(19) United States
(12) Patent Application Publication
(10) Pub. No.: US 2005/0105755 A1
(43) Pub. Date: May 19, 2005

(54) Modified earphone structure having closable opening

(76) Inventor: Wen Hsiang Yueh, Hsin Chuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/713,007

(22) Filed: Nov. 17, 2003

(51) Int. Cl. H04R 25/00

(52) U.S. Cl. 381/371; 381/370

(57) ABSTRACT

A modified earphone structure having a closable opening is formed by connecting two cover bodies with a headband. The cover body has a first shell and a second shell. The first shell has at least a first opening, and forms a first connection portion. The second shell has at least a second opening, and forms a second connection portion. The second opening corresponds to the first opening. The second connection portion is retained within the first connection portion. A loudspeaker is arranged in the second shell. The first shell can be turned through the first connection portion to connect the first opening with the second opening so that external sound sources can enter a user's ears, or the second opening can be closed with the first shell to block external sound sources from entering a user's ears.

### FIELD OF THE INVENTION

The present invention relates to a modified earphone structure having a closable opening and, more particularly, to an earphone having a closable opening, whereby external sound sources can enter a user's ears when openings of the earphone body correspond to each other, and external sound sources can be blocked from entering a user's ears when the openings thereof don't correspond to each other.

### BACKGROUND OF THE INVENTION

Earphones are common articles in everyday life. Their primary functions are to send sound signals into people's ears, and they are usually used for communication, broadcast and other auditory functions.

Existent earphones can be classified into the ear wrapping-type and the earplug-type. An earplug-type earphone is small and conveniently portable. However, it is necessary to plug the earplug-type earphone into the ears, and sometimes, it is difficult to position the earplug-type earphone in the ears. Moreover, wearing the earplug-type earphone is more uncomfortable, and external sound sources can easily enter a user's ears.

FIG. 1 shows a conventional ear wrapping-type earphone 1, which comprises a headband 11 and ear muffs 12. An ear wrapping-type earphone has the advantage that external sound sources can't easily enter a user's ears. However, a user needs to take off the ear muffs 12 if he wants to hear external sounds,

For instance, for service personnel who continually answers phones, it is very inconvenient to wear an ear wrapping-type earphone to listen to music because the ear wrapping-type earphone must be removed to answer a call.

In the disclosure of R.O.C. Pat. No. 491,449, an ear wrapping-type earphone is proposed to accomplish more comfortable wear and also block the influence of external sounds. However, this disclosure does not resolve the above-mentioned inconvenience.

Accordingly, the present invention aims to provide a modified earphone structure having a closable opening to solve the above problem in the prior art.

### SUMMARY OF THE INVENTION

The primary object of the present invention is to provide a modified earphone structure having a closable opening. The earphone structure is formed by connecting two cover bodies with a headband. The cover body comprises a first shell and a second shell. The first shell has at least a first opening, and forms a first connection portion. The second shell has at least a second opening, and forms a second connection portion. The second opening corresponds to the first opening. The second connection portion is retained within the first connection portion. A loudspeaker is arranged in the second shell.

The first shell can be turned through the first connection portion to connect the first opening with the second opening so that external sound sources can enter a user's ears, or close the second opening with the first shell to block external sound sources from entering a user's ears.

### BRIEF DESCRIPTION OF THE DRAWINGS

The various objects and advantages of the present invention will be more readily understood from the following detailed description when read in conjunction with the appended drawings, in which:

FIG. 1 shows a conventional ear wrapping-type earphone;

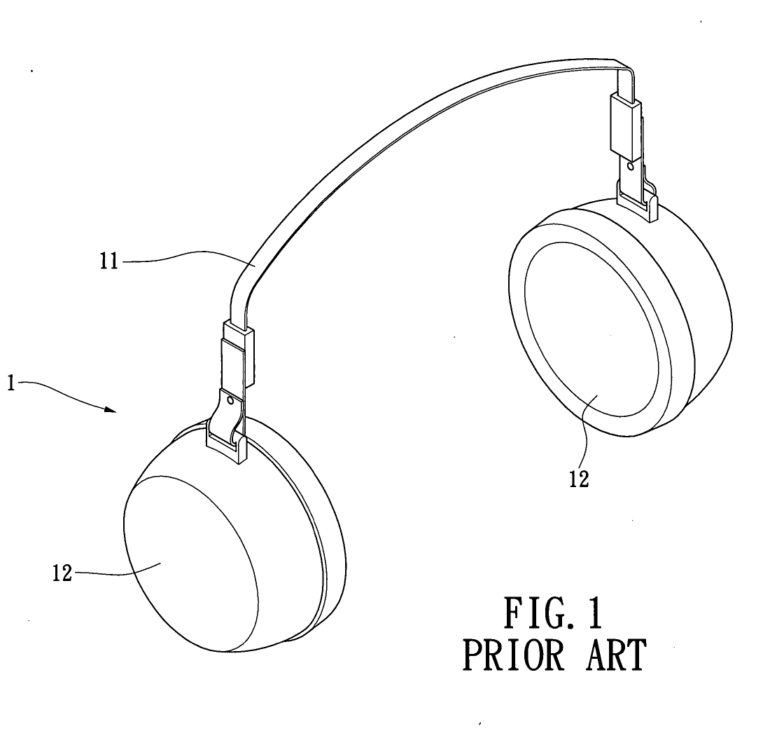

FIG. 2 is a structure diagram of the present invention;

FIG. 3 shows the internal structure of a cover body of the present invention;

FIG. 4 shows a first embodiment of the present invention;

FIG. 5 shows a second embodiment of the present invention;

FIG. 6 is a block diagram of the second embodiment of the present invention; and

FIG. 7 is a flowchart of the second embodiment of the present invention.

### DETAILED DESCRIPTION OF THE PREFERRED EMBODIMENTS

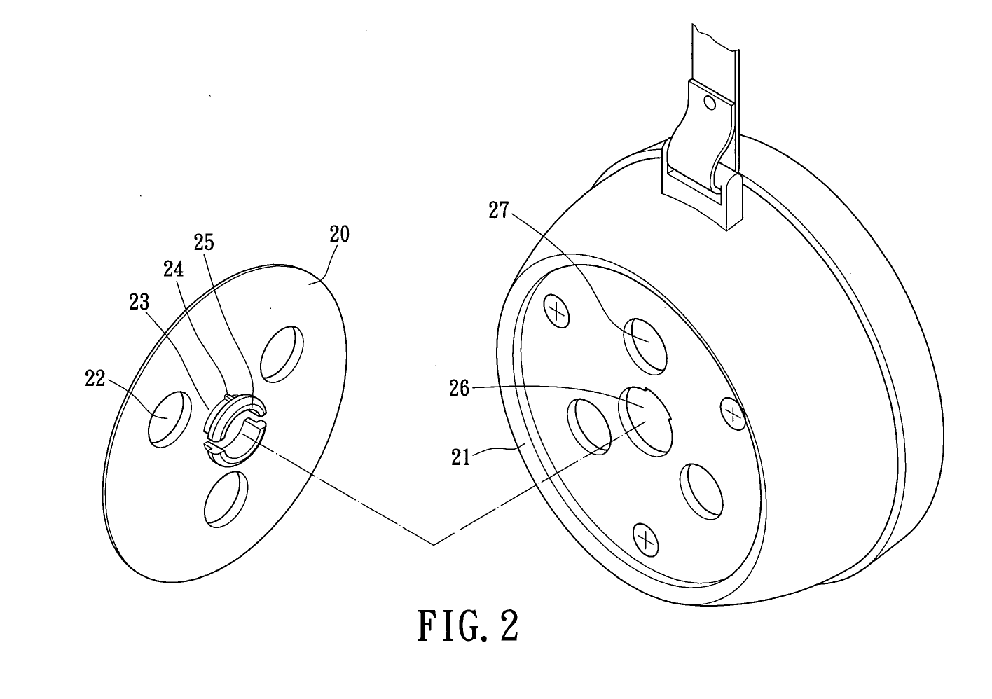

The present invention provides a modified earphone structure having a closable opening. The earphone structure is formed by connecting two cover bodies with a headband. As shown in FIG. 2, the cover body comprises a first shell 20 and a second shell 21. The first shell 20 has a first opening 22 and a first connection portion 23. The first opening 22 comprises a plurality of through holes. The first connection portion 23 has a hook 24 and a protruding groove 25. The second shell 21 has a second opening 27 and a second connection portion. The second opening 27 comprises a plurality of through holes. The second connection portion has a concave groove 26.

A user can turn the first connection portion 23 of the first shell 20 to connect the first opening 22 with the second opening 27 so that external sound sources can enter the user's ears, or close the second opening 27 with the first shell 20 to block external sound sources from entering the user's ears.

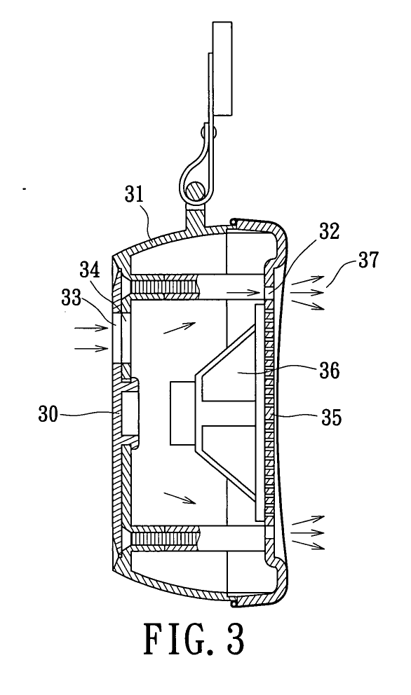

As shown in FIG. 3, the internal structure of the cover body comprises a plurality of through holes 32, a first opening 33, a second opening 34, a plurality of sound holes 35 and a loudspeaker 36.

When the user turns the first shell 30 to connect the first opening 33 with the second opening 34 of a second shell 31, an external sound source 37 can enter the user's ears via the through holes 32. On the contrary, when the first shell 30 closes the second opening 34, the external sound source 37 is blocked from entering the user's ears.

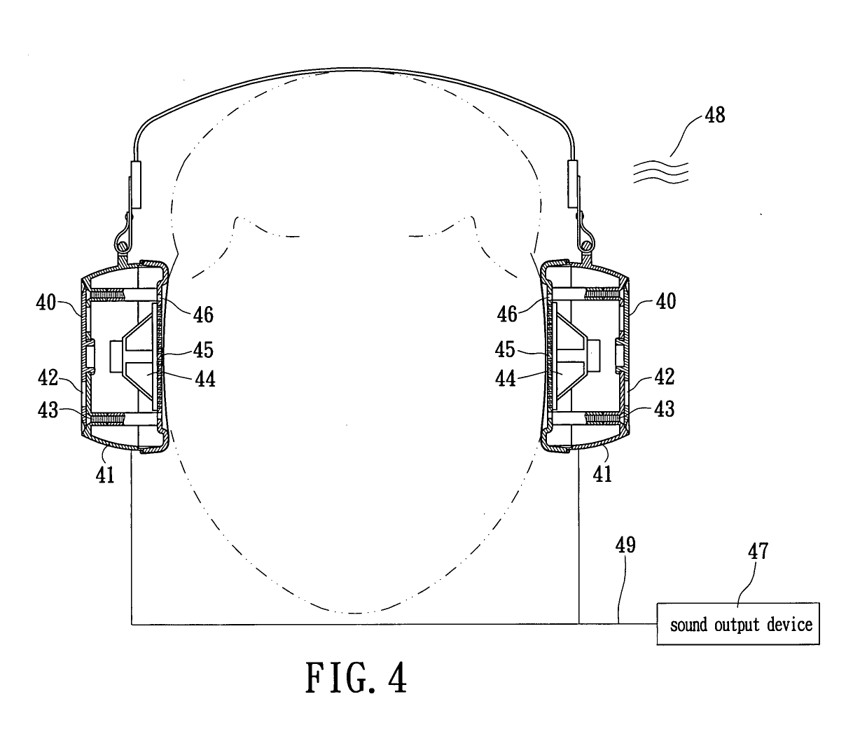

As shown in FIG. 4, when the user wants to listen to music, he turns a first shell 40 so that a first opening 42 does not correspond to a second opening 43 of a second shell 41 and an external sound source 48 can't enter the user's ears. Music can thus be sent from a sound output device 47 through sound holes 45 of a loudspeaker 44 to the user's ears via a lead 49.

Conversely, when the user doesn't want to listen to music, he can turn the first shell 41 so that the first opening 42 corresponds to the second opening 43 and external sound source 48 can enter the user's ears via the through holes 46 at the inner side of the second shell 41.

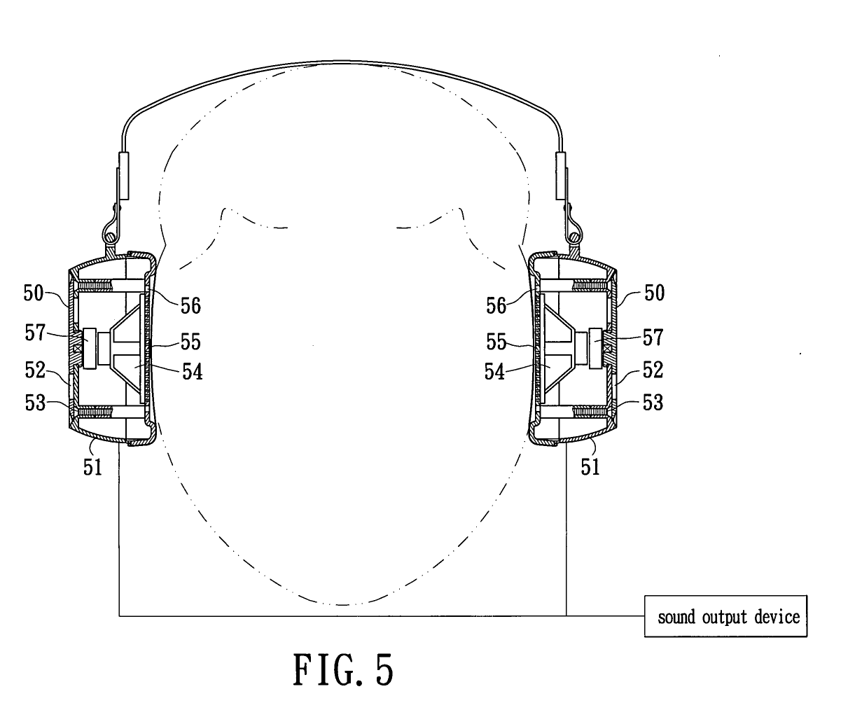

As shown in FIG. 5, the cover body comprises a first shell 50, a second shell 51, a plurality of through holes 52, a first opening 53, a second opening 54, a plurality of sound holes 55, a loudspeaker 56, a motor 57, a measurement unit (not shown) and a control unit (not shown).

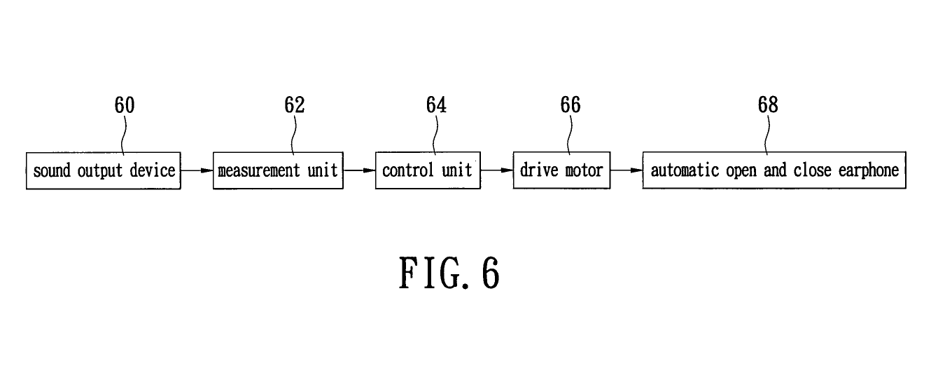

As shown in FIG. 6, a sound output device 60 outputs a first voltage to a measurement unit 62. The sound output device 60 can be an MP3 Walkman or a conventional Walkman. The measurement unit 62 can be a voltage sensor. The measurement unit 62 sends a second voltage to a control unit 64. The control unit 64 can be a relay. The control uni. 64 drives a motor 66 to open or close automatically an earphone 68 according to the second voltage.

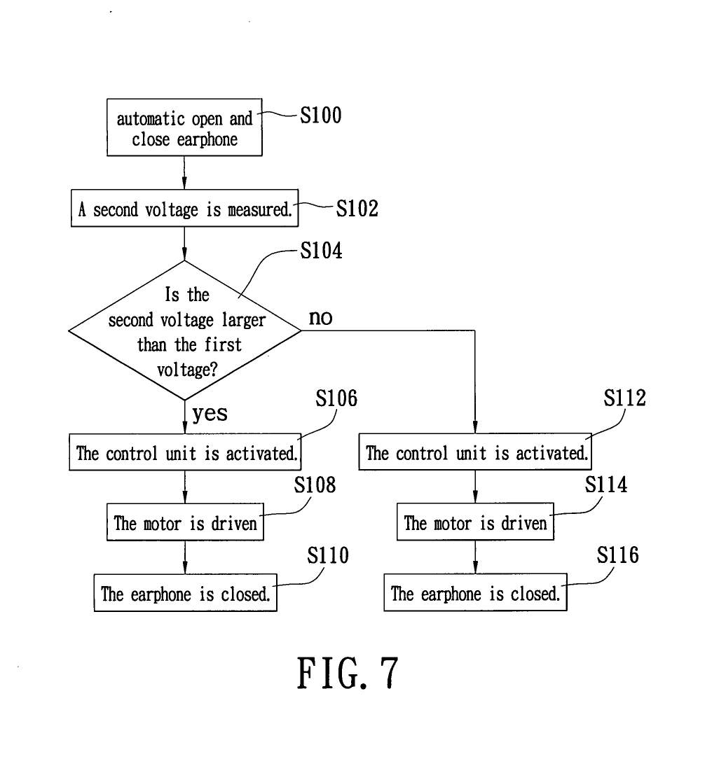

As shown in FIG. 7, the method of automatically opening or closing the earphone comprises the following steps. First, a first voltage is set (Step 100). The first voltage is the voltage value when the sound output device has no output voltage. At this time, the earphone is open. When the level of the first voltage changes, the measurement unit measures out a second voltage (Step 102). Next, whether the second voltage is larger than the first voltage is determined (Step 104). If the answer is yes, the second voltage is output to activate the control unit (Step 106). The control unit then drives the motor according to the second voltage (Step 108). The motor automatically turns the first shell a first angle so that the through holes of the first shell do not correspond to the through holes of the second shell, hence accomplishing the effect of automatically closing the earphone (Step 110).

On the contrary, if the second voltage is determined to be smaller than the first voltage, the second voltage is output to activate the control unit (Step 112). The control unit then drives the motor according to the second voltage (Step 114). The motor automatically turns the first shell a second angle so that the through holes of the first shell correspond to the through holes of the second shell, hence accomplishing the effect of automatically opening the earphone (Step 110).

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

1. A modified earphone structure having a closable opening, said earphone structure being formed by connecting two cover bodies with a headband, said cover body comprising:
a first shell at least having a first opening and forming a first connection portion; and
a second shell at least having a second opening and forming a second connection portion, said second opening corresponding to said first opening, said second connection portion being retained within said first connection portion, and a loudspeaker being arranged in said second shell;
whereby said first shell is turned through said first connection portion to connect said first opening with said second opening or close said second opening with said first shell.

2. The modified earphone structure having a closable opening as claimed in claim 1, wherein said first opening has a plurality of through holes.

3. The modified earphone structure having a closable opening as claimed in claim 1, wherein said first connection portion has a hook and a protruding groove.

4. The modified earphone structure having a closable opening as claimed in claim 1, wherein said second opening has a plurality of through holes.

5. The modified earphone structure having a closable opening as claimed in claim 1, wherein said second connection portion has a concave groove.

6. The modified earphone structure having a closable opening as claimed in claim 1, wherein a plurality of through holes and a plurality of sound holes are further provided in an inner side of said second shell.

7. The modified earphone structure having a closable opening as claimed in claim 6, wherein the diameter of said sound hole is smaller than that of said through hole.

8. The modified earphone structure having a closable opening as claimed in claim 6, wherein said sound holes are densely distributed around said loudspeaker.

9. The modified earphone structure having a closable opening as claimed in claim 1, wherein a soft cushion is provided at an edge of said second shell.

10. A modified earphone structure having a closable opening, said earphone structure being formed by connecting two cover bodies with a headband, each of said cover body having a lead connected to a sound output device, said cover body comprising:
a first shell at least having a first opening and forming a first connection portion; and
a second shell at least having a second opening and forming a second connection portion, said second opening corresponding to said first opening, said second connection portion being retained within said first connection portion, a loudspeaker being arranged in said second shell;
a motor arranged in said second shell;
a measurement unit for measuring the change of a first voltage level; and
a control unit for driving said motor according to the change of a second voltage of said measurement unit;
whereby said ear cuff is opened or closed according to the change of said first voltage of said measurement unit, said first voltage is an output voltage of said sound output device, said measurement unit sends said second voltage to said control unit for driving said motor when said first voltage changes, said motor automatically turns said first shell a first angle so that said first opening of said first shell corresponds to said second opening of said second shell and external sound sources enters a user's ears, or turns said first shell a second angle so that said first opening of said first shell does not correspond to said second opening of said second shell and blocks external sound sources from entering a user's ears.

11. The modified earphone structure having a closable opening as claimed in claim 10, wherein said measurement unit, said control unit and said motor are arranged in said second shell.

12. The modified earphone structure having a closable opening as claimed in claim 10, wherein said first opening has a plurality of through holes.

13. The modified earphone structure having a closable opening as claimed in claim 10, wherein said first connection portion has a hook and a protruding groove.

14. The modified earphone structure having a closable opening as claimed in claim 10, wherein said second opening has a plurality of through holes.

15. The modified earphone structure having a closable opening as claimed in claim 10, wherein a plurality of through holes and a plurality of sound holes are further provided in an inner side of said second shell.

16. The modified earphone structure having a closable opening as claimed in claim 15, wherein the diameter of said sound hole is smaller than that of said through hole.

17. The modified earphone structure having a closable opening as claimed in claim 15, wherein said sound holes are densely distributed around said loudspeaker.

18. The modified earphone structure having a closable opening as claimed in claim 15, wherein a soft cushion is provide at an edge of said second shell.

19. The modified earphone structure having a closable opening as claimed in claim 10, wherein said measurement unit is a voltage sensor.

20. The modified earphone structure having a closable opening as claimed in claim 10, wherein said control unit is a relay.

21. The modified earphone structure having a closable opening as claimed in claim 10, wherein both said first angle and said second angle are 60 degrees.

22. The modified earphone structure having a closable opening as claimed in claim 10, wherein said sound output device is an MP3 Walkman, a CD Walkman, or a conventional radio set.
